(19) United States
(12) Patent Application Publication
(10) Pub. No.: US 2004/0083137 A1
(43) Pub. Date: Apr. 29, 2004

(54) System and method for transactions with web-enabled devices including a record stored at a uniform resource locator

(76) Inventors: Curtis Reese, Boise, ID (US); Grady Cooper, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/283,578

(22) Filed: Oct. 29, 2002

(51) Int. Cl. G06F 17/60

(52) U.S. Cl. 705/26

(57) ABSTRACT

A method of doing business preferably includes making a transaction on a first web-enabled device, generating a Uniform Resource Locator (URL) that references a stored record of that transaction, outputting the URL from the first web-enabled device to a user, receiving the URL with a second web-enabled device, and, with the second web-enabled device, providing an output to the user based on the record of the transaction stored at the URL.

### TECHNICAL FIELD

The present invention relates to a system and method for conducting transactions with web-enabled devices including use of a record of the transaction stored at a Uniform Resource Locator.

### BACKGROUND OF THE INVENTION

A kiosk is a small portable structure with one or more open sides. Traditionally, kiosks provide the owner with physical structure to display, distribute, or vend goods or services. For example, a kiosk may be used by a museum to distribute maps of the museum or pamphlets advertising special attractions that are on display. A kiosk may also be used in a shopping mall to display goods for sale.

Additionally, kiosks may include electronic devices, e.g., printers, cameras, etc., that provide the user with a particular service. In recent years, computers have also been used as part of some kiosks. Computers enable kiosks to display information and vend goods and services electronically. With the increase in internet shopping and services, web-enabled kiosks have the capacity to provide more information, services, and goods by accessing the resource available on the internet.

In some circumstances, it may be desirable for a user to initiate a transaction at one location and complete the transaction at a second location. For example, the user may wish to order goods or services at one location and then receive the ordered goods or services at a second location. In other circumstances, a user may wish to initiate a transaction at one location, be interrupted and need to complete the transaction at a second location. In such a case, it would be preferable if the user did not have to completely restart the transaction at the second location, but could pick up essentially where the transaction was interrupted at the first location.

Consequently, there is a need in the art for a means and method of supporting such two-part transactions as efficiently as possible.

### SUMMARY OF THE INVENTION

In one of many possible embodiments, the present invention provides a method of doing business by making or initiating a transaction on a first web-enabled device, generating a Uniform Resource Locator (URL) that references a stored record of that transaction, outputting the URL from the first web-enabled device to a user, receiving the URL with a second web-enabled device, and, with the second web-enabled device, providing an output to the user based on the record of the transaction stored at the URL.

In another of many possible embodiments, the present invention provides a system for electronically purchasing products or services, the system preferably including: a computing device; a user interface, connected to said computing device, for receiving user input that initiates a transaction to purchase a product or service; a data transfer device, connected to the computing device, for interfacing with a portable electronic device of a user and loading a uniform resource location (URL) to the portable electronic device, where the URL references a stored record of the transaction; and a connection between the computing device and a computer network, the network including a storage location referenced by the URL.

### BRIEF DESCRIPTION OF THE DRAWINGS

The accompanying drawings illustrate various embodiments of the present invention and are a part of the specification. Together with the following description, the drawings demonstrate and explain various principles of the present invention. The illustrated embodiments are examples of the present invention and do not limit the scope of the invention.

FIG. 1 is a flowchart illustrating a transaction method according to one embodiment of the present invention.

FIG. 2 is a flowchart illustrating a method of transferring a URL from one electronic device to another according to an embodiment of the present invention.

FIG. 3a is a block diagram illustrating one embodiment of a kiosk according to the present invention.

FIG. 3b is a block diagram illustrating one embodiment of a web-enabled device according to the present invention.

FIG. 3c is a block diagram illustrating a web-enabled device according to another embodiment of the present invention.

FIG. 4a is a block diagram illustrating an exemplary screenshot from the embodiment illustrated in FIG. 3a.

FIG. 4b is a block diagram illustrating another exemplary screenshot from the embodiment illustrated in FIG. 3a.

FIG. 5 is a schematic diagram illustrating a method of eCommerce carried out according to an embodiment of the present invention.

Throughout the drawings, identical reference numbers designate similar, but not necessarily identical, elements.

### DETAILED DESCRIPTION OF THE PREFERRED EMBODIMENTS

Access to resources on the internet, or a device connected to the internet, generally requires a specific path or Uniform Resource Locator (URL). By inputting a specific URL to the internet, a user may reference the information or application stored at the URL.

In one of many possible embodiments, the present invention provides a method and means for vending goods and services using one or more internet-based kiosks, computers, or devices. The kiosk, computer, or device enables the user to purchase or access specific goods or services using the internet. When a transaction is made using the invention, a URL is given to the user providing an “access key” to the particular privilege or service purchased. The URL is transferred to a portable user-carried device, e.g., a PDA, mobile phone, watch, etc., and stored. Later, when convenient to the user, the URL is sent from the portable user-carried device to another internet-connected kiosk, computer, or device, capable of recognizing or providing the purchased privilege or service.

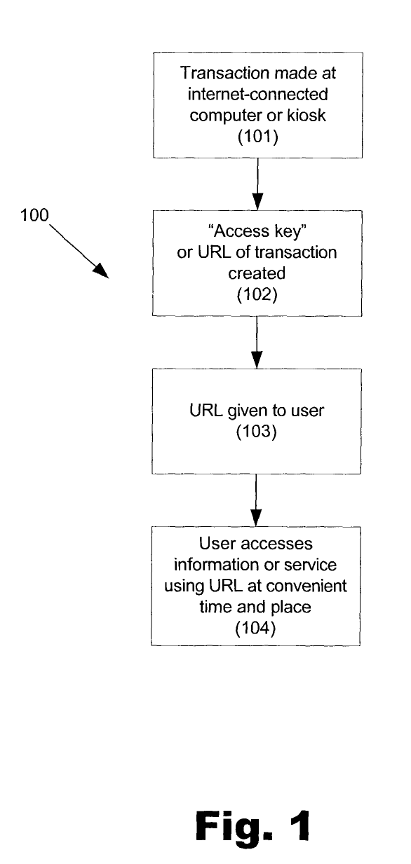

FIG. 1 is a flowchart illustrating a method of conducting a transaction (100) according to an embodiment of the present invention. As shown in FIG. 1, the method begins when a transaction is made at a web-enabled kiosk or user computer (step 101). As used herein, a “web-enabled device” is any device connected to the Internet, World Wide Web or other computer network. The transaction consists of, for example, a purchase or exchange of information, e.g., name, email address, phone number, etc. If the transaction is a purchase, any form of payment, e.g., credit card, online check, etc., may be used to make the purchase via the internet.

Once the user submits the required information for the transaction, a URL reference designating the transaction is created (step 102). The URL is preferably an HTTP (hypertext transfer protocol) statement containing information associating the user with the transaction and may contain user identification information, computer instructions, or any other content necessary for providing an internet-based service to the user.

The URL is then given to the user (step 103) as an “access key,” providing the user with the ability to directly access the content stored at the URL (step 104). In one exemplary embodiment of the invention, the URL is electronically transferred to a portable user-carried device, e.g., a PDA, mobile phone, watch, etc., capable of storing the URL.

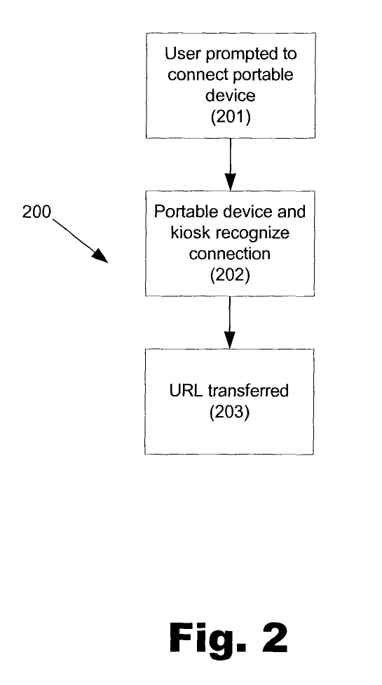

In transferring a URL from one electronic device to another, the method illustrated in FIG. 2 may be used. The method (200) is initiated when a user is prompted to connect a portable device to a web-enabled device, e.g., computer or kiosk (step 201). The user prompt may be a visual or audible instruction to connect the portable device web-enabled device. The connection may be made using cables, e.g., serial, USB, etc., or by using wireless protocols such as 802.11, BlueTooth, etc. In one exemplary embodiment, a wireless connection is made.

Once the web-enabled device and portable user-carried device recognize the connection (step 202), the transfer of the URL from one device to the other is made (step 203). The stored location of the URL may be determined by the user or the software governing the URL transfer. An example of software available to facilitate the transfer of data from one electronic device to another is “eSquirt” software. This software contains the computer instructions and protocol necessary to send and receive data from one infrared “beacon” to another.

By using, for example, the method (200) of FIG. 2, a user may store the URL reference on a portable user-carried device (step 103; FIG. 1). When desired, the user may also use the same method (200) to transfer the URL reference from the portable user-carried device to another web-enabled device, thereby accessing the privilege provided by the URL transaction reference (step 104; FIG. 1). Additionally, a user without a portable device capable of storing and transferring the URL may record and transfer the URL manually using an available input device, e.g., keyboard, mouse, etc.

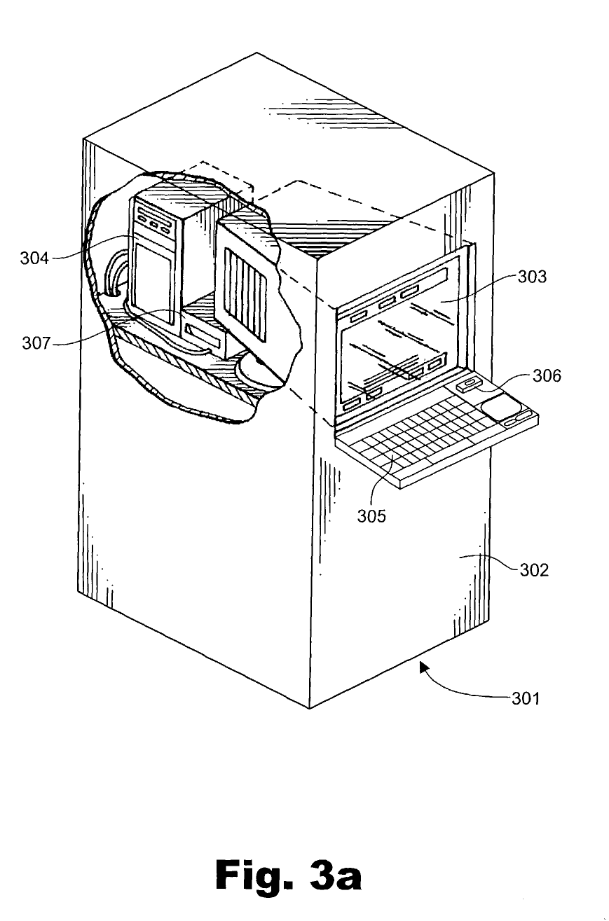

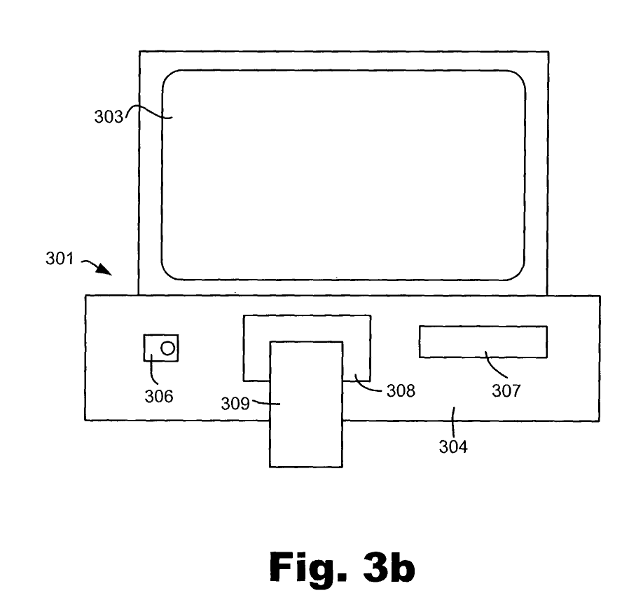

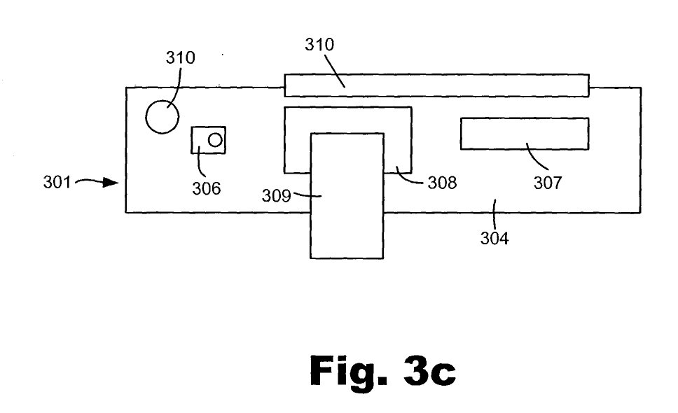

FIG. 3a is an embodiment of a kiosk capable of executing the method illustrated in FIG. 1. The kiosk (301) may be placed in any publicly accessible place, for example, an airport, shopping mall, hotel lobby, or any other convenient location. A casing (302) may be used to appropriately protect or decorate the kiosk. A graphics monitor (303) is used to display internet-based information and products available and give prompts to the user, e.g., “Please, interface your portable device with the kiosk.”

A computing system (304) is used to process all the data, i.e., graphics, internet protocol, user input, etc., for the kiosk (301). Other possible components include a modem or network interface card (307), an input device (305), e.g., keyboard, mouse, etc., and a data transfer device (306). One exemplary embodiment of the data transfer device (306) includes an infrared transfer device capable of wirelessly transferring and receiving data.

The modem or network interface card (307) is used to interface the kiosk to the internet. The input device (305) in combination with the graphics display (303) allows the user to navigate information, e.g., offers for products, services, etc., on the internet, and make one or more selections. The input device (305) is also used to enter user information, such as, credit card number, name, email address, etc., used in making a transaction. The data transfer device (306) is used to electronically send and receive URL transaction references.

FIG. 3b is similar to FIG. 3a in that FIG. 3b illustrates an embodiment of a web-enabled device capable of executing the method described in FIG. 1. The web-enabled device of FIG. 3b is specifically used for providing a product or service to the user. This particular web-enabled device (301) comprises a computing system (304), a graphics monitor (303), a data transfer device (306), a modem or network interface card (307), a service unit (308), and a product (309).

One difference between the “kiosk” illustrated in FIG. 3a and the “web-enabled device” illustrated in FIG. 3b is size. The web-enabled device (301) contains all of the necessary components to execute the exemplary method of FIG. 1 without the large casing commonly used for a kiosk. Essentially, the kiosk of FIG. 3a is a web-enabled device with a casing provided for purposes such as protection, presentation, etc. The term “eReference commercial kiosk” will be used herein to describe various embodiments of the present invention including both kiosks and smaller web-enabled devices.

As an example, suppose a user had purchased a movie ticket using an eReference commercial kiosk at a hotel and a URL reference of the transaction is stored on the user's Personal Digital Assistant (PDA) by interfacing the PDA with the kiosk. The interface between the PDA and kiosk may be wired or wireless. Upon arriving at the movie theater, the user approaches an eReference commercial kiosk such as that illustrated FIG. 3b. Using the graphics display (303), the eReference commercial kiosk (301) prompts the user to interface the PDA with the eReference commercial kiosk (301). This may be done, for example, by placing the portable device (the PDA in this example) in front of the eReference commercial kiosk (301), facing the data transfer device (306). By placing the PDA in front of the data transfer device (306), the eReference commercial kiosk (301) and the PDA make a wireless connection, using, for example, infrared signaling, and the URL is transferred from the PDA to the eReference commercial kiosk (301).

Using the URL, the computing system (304) and modem or network interface card (307) work together to access the internet-based information corresponding to the earlier transaction conducted by the user, e.g., the number of tickets purchased, movie title, movie time, etc. The service unit (308) in this example is a printer that prints the product (309), e.g., movie tickets.

Alternatively, the service unit (308) may be a device internal to the kiosk that controls a gate allowing entrance to the theater upon reception of an appropriate URL reference at which is stored a record of the user's earlier purchase of admission to the show. Other embodiments of the eReference commercial kiosk may include electronic devices, e.g., printers, cameras, video recorders, recordable CD players, video game consoles, etc., that provide a specific service to the user. While a graphics monitor is part of the exemplary embodiment, an eReference commercial kiosk may or may not use a graphics monitor. Instead, written or audio instructions may be used to prompt user action.

FIG. 3c is similar to FIG. 3b in that FIG. 3c is an eReference commercial kiosk. The kiosk (301a) of FIG. 3c comprises the same elements as the kiosk of FIG. 3b, i.e., a computing system (304), a data transfer device (306), a modem or network interface card (307), a service unit (308), and a product (309), with the exception being a graphics monitor. Instead of a graphics monitor, the kiosk (301a) may include a speaker (310) through which the computing system (304) audibilizes instructions for a user, and/or a text display (310) on which the computing system (304) displays written instructions for the user.

The functions of the eReference commercial kiosk may be divided into two categories. One function is to allow a user to make transactions and provide a URL transaction reference, the other is to receive a URL transaction reference and provide the specific service or product, which is the subject of the earlier transaction as specified by the information at the URL. Therefore, there are many possible variations of the eReference commercial kiosk corresponding to a wide variety of products and services that could be provided by embodiments of the present invention. In one exemplary embodiment, one type of eReference commercial kiosk is used only for making transactions and a variety of smaller eReference commercial kiosks provide the specific product or service.

Alternatively, the transaction could be made at a user's computer, e.g., a home or work computer, where the user's computer is equipped with a data transfer device capable of transferring a URL reference of the transaction to a portable user-carried device. The user may later use the URL reference to access the specific service at a corresponding eReference commercial kiosk.

Similarly, a transaction may be made at an eReference commercial kiosk and the goods or services later accessed through a user's own computer. An example of this form of eCommerce is an eReference commercial kiosk equipped to take digital photos. Instead of receiving the photo instantly, a URL reference of the photo is stored on a portable user-carried device. Later, by transferring the URL reference to a home computer, the user may access and print the photo stored at the URL.

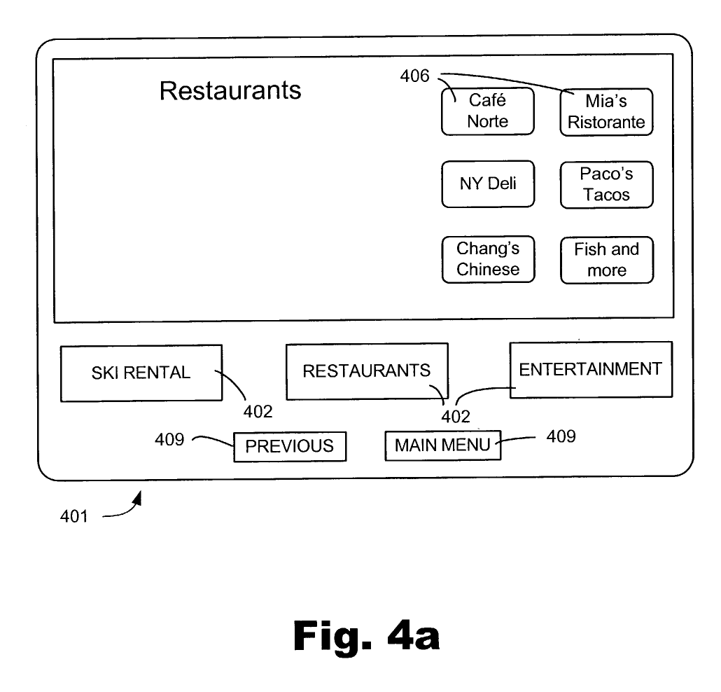

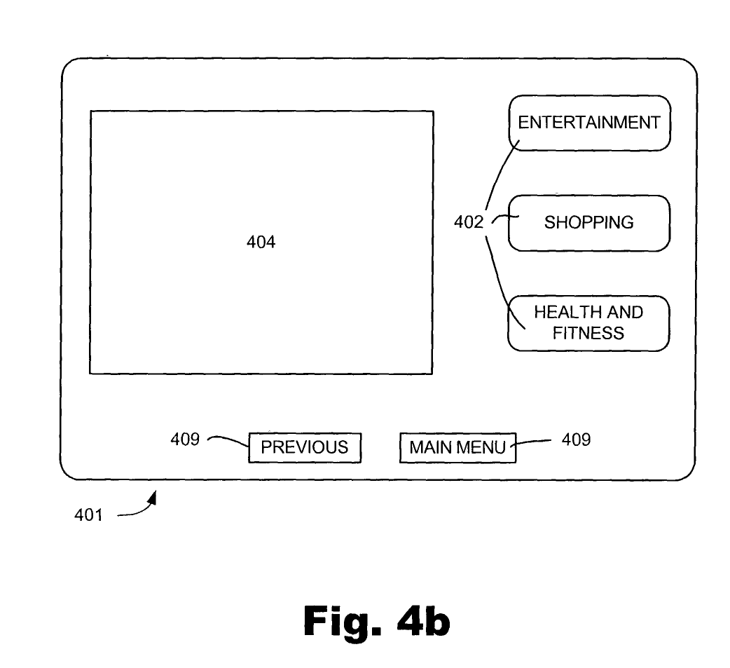

FIG. 4a is a block diagram illustrating an embodiment of a graphic presentation used by an eReference commercial kiosk. This particular kiosk is used by a ski resort to facilitate eCommerce. As shown in FIG. 4a, there are a variety of categories (402), which guide the user to find and select a desired product or service. Once a category has been selected (in this example, the restaurants category has been selected), the monitor displays subcategories (406) that are used to further guide the selection of the user. Navigation buttons (409) are also provided for user's convenience.

FIG. 4b is similar to FIG. 4a in that FIG. 4b is a block diagram illustrating an embodiment of a graphic presentation used by an eReference commercial kiosk. The kiosk of FIG. 4b may be located anywhere and provides the user with a set of categories (402) to guide user selection. Once a category is selected more information corresponding to that category is displayed (404). Again, navigation tools (409) are provided to help the user to search for a product.

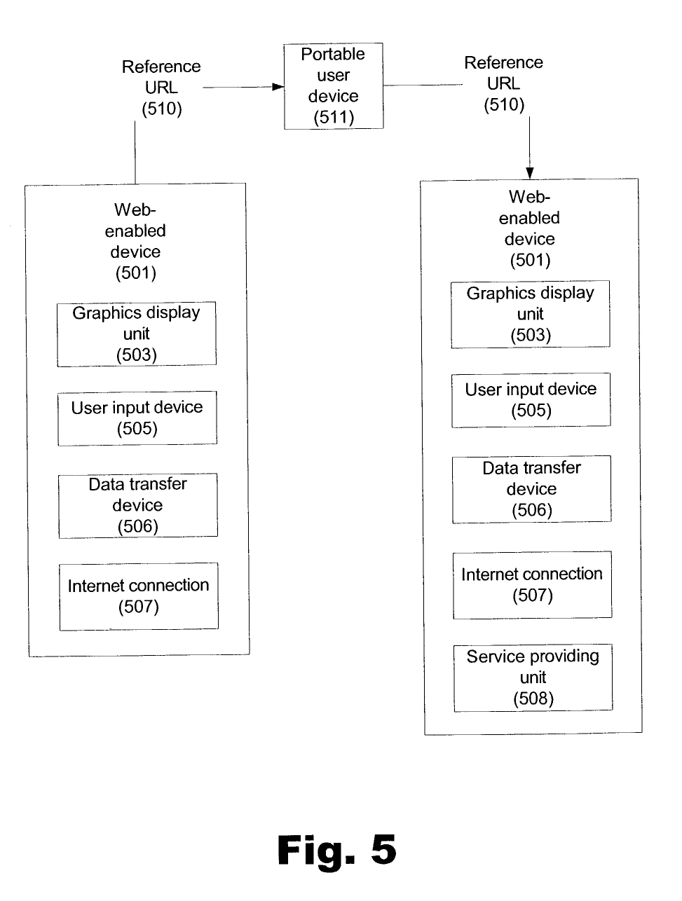

FIG. 5 is a schematic diagram illustrating one embodiment according to the present invention of a method of eCommerce. As shown in FIG. 5, a web-enabled device (501a), comprising, a graphics display unit (503), a user input device (505), a data transfer device (506), and an internet connection (507), is used to make a transaction. A URL reference that acts as a receipt or memorandum of the transaction (510) is then sent to a portable device (511) carried by the user. Using the portable device (511), the user later sends the reference URL (510) to another web-enabled device (501b), e.g., a computer, kiosk, etc., comprised of a graphics display unit (503), a user input device (505), a data transfer device (506), an internet connection (507), and a service providing unit (508), to access the privilege, goods or services purchased through the first device (501a) as described at the reference URL.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best illustrate the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of doing business, said method comprising:
making a transaction on a first web-enabled device;
generating a Uniform Resource Locator (URL) that references a stored record of said transaction;
outputting the URL from the first web-enabled device to a user;
receiving the URL with a second web-enabled device; and
with the second web-enabled device, providing an output to the user based on said record of said transaction stored at said URL.

2. The method of claim 1, wherein said making a transaction on a first web-enabled device comprises receiving user information.

3. The method of claim 2, wherein said user information comprises an electronic form of payment for said transaction.

4. The method of claim 2, wherein said user information comprises information about the user.

5. The method of claim 1, wherein said outputting the URL to the user comprises:
prompting the user to interface a portable electronic device with said first web-enabled device;
recognizing when an interface between said portable electronic device and said first web-enabled device is made; and
electronically transferring said URL from said first web-enabled device to said portable electronic device.

6. The method of claim 5, wherein said prompting the user comprises a visible instruction.

7. The method of claim 5, wherein said prompting the user comprises an audible instruction.

8. The method of claim 5, wherein said transferring said URL from the first web-enabled device to the portable electronic device comprises passing URL data through a cable connecting said portable electronic device with said first web-enabled device.

9. The method of claim 5, wherein said transferring said URL from the first web-enabled device to the portable electronic device comprises wirelessly transferring URL data.

10. The method of claim 5, wherein said receiving the URL from the user with a second web-enable device comprises:
prompting the user to interface the portable electronic device with said second web-enabled device;
recognizing when a connection between said portable electronic device and said second web-enabled device is made; and
transferring said URL from said portable electronic device to said second web-enabled device.

11. The method of claim 10, wherein said prompting the user comprises a visible instruction.

12. The method of claim 10, wherein said prompting the user comprises an audible instruction.

13. The method of claim 10, wherein said transferring said URL from the portable electronic device to the second web-enabled device comprises passing URL data through a cable.

14. The method of claim 10, wherein said transferring said URL from the portable electronic device to the second web-enabled device comprises wirelessly transferring URL data.

15. The method of claim 1, wherein said output comprises a web-based product or service.

16. The method of claim 1, wherein said output comprises a privilege provided by an electronic device connected to said second web-enabled device.

17. A system for electronically purchasing products or services, said system comprising:
a computing device;
a user interface, connected to said computing device, for receiving user input that initiates a transaction to purchase a product or service;
a data transfer device, connected to said computing device, for interfacing with a portable electronic device of a user and loading a uniform resource location (URL) to the portable electronic device, wherein said URL references a stored record of said transaction; and
a connection between said computing device and a computer network, the network including a storage location referenced by said URL.

18. The system of claim 17, further comprising a kiosk in which said computing device, user interface, and data transfer device are disposed.

19. The system of claim 17, wherein said connection between said computing device and the computer network comprises a modem or network interface card.

20. The system of claim 19, wherein said modem is a wireless modem or wireless network interface card for interfacing the computing device with the computer network.

21. The system of claim 17, wherein the computer network is the Internet.

22. The system of claim 17, wherein said user interface comprises a graphics display for displaying text and images.

23. The system of claim 17, wherein said user interface comprises a keyboard.

24. The system of claim 22, wherein said user interface comprises a touchpad, trackball or mouse.

25. The system of claim 17, wherein said data transfer device comprises an infrared transmitter for wirelessly transferring said URL to the portable user-carried device.

26. The system of claim 17, further comprising:
a second computing device also connected to the computer network including the storage location referenced by the URL;
a second data transfer device, connected to said second computing device, for receiving the URL transmitted from the portable electronic device of the user; and
an output unit, connected to said second computing device, for providing an output to the user based on the record of said transaction stored at the URL.

27. The system of claim 26, further comprising a kiosk in which said second computing device and second data transfer device are disposed.

28. The system of claim 26, wherein said computer network is the Internet.

29. The system of claim 26, wherein said second data transfer device comprises an infrared receiver for wirelessly receiving said URL from said portable electronic device.

31. The system of claim 26, further comprising a modem or network interface card connecting said second computing device to the computer network.

32. The system of claim 31, wherein said modem is a wireless modem or wireless network interface card.

33. A system for conducting electronic transactions comprising:
means for initiating a transaction on a first web-enabled device;
means for generating a Uniform Resource Locator (URL) that references a stored record of said transaction;
means for outputting the URL from the first web-enabled device to a user;
means for receiving the URL with a second web-enabled device; and
with the second web-enabled device, means for providing an output to the user based on said record of said transaction stored at said URL.

34. The system of claim 33, wherein said means for initiating a transaction on a first web-enabled device comprises means for receiving information about a user.

35. The system of claim 34, wherein said information comprises an electronic form of payment for said transaction authorized for use by said user.

36. The system of claim 33, wherein said means for outputting the URL to the user comprises:
means for electronically transferring said URL from said first web-enabled device to said portable electronic device.

37. The system of claim 36, further comprising means for prompting the user to interface said portable electronic device and said first web-enabled device.

38. The system of claim 33, wherein said means for receiving the URL from the user with a second web-enable device comprises:
means for transferring said URL from a portable electronic device of said user to said second web-enabled device.

39. The system of claim 38, further comprising means for prompting the user to interface said portable electronic device and said second web-enabled device.

40. The system of claim 33, wherein said output comprises a web-based product or service.
